(19) United States
(12) Patent Application Publication
(10) Pub. No.: US 2001/0029752 A1
(43) Pub. Date: Oct. 18, 2001

(54) Thermal immobilization of colloidal metal nanoparticles

(76) Inventors: Michael J. Natan, Los Altos, CA (US); Brian D. Reiss, State College, PA (US); Melinda H. Keefe, Evanston, IL (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 09/729,025

(22) Filed: Dec. 4, 2000

Related U.S. Application Data
(60) Provisional application No. 60/168,872, filed on Dec. 3, 1999.

(51) Int. Cl. C03C 27/02

(52) U.S. Cl. 65/59.7

(57) ABSTRACT

Methods for the preparation of novel metal nanoparticle and glass composites are disclosed. The composites themselves are also disclosed. In particular, a method for the preparation of colloidal metal nanoparticles imbedded in a glass surface is disclosed. Further disclosed is a method for making an array of zeptoliter vials by preparing a composite of colloidal metal nanoparticles imbedded in a glass surface, and dissolving the colloidal metal nanoparticles.

### RELATED APPLICATIONS

This application claims the benefit of the filing date of United States Provisional Application Ser. No. 60/168,872, entitled “Thermal Immobilization of Colloidal Au Nanoparticles”, filed Dec. 3, 1999.

### FIELD OF THE INVENTION

The present invention relates generally to composites of metal nanoparticles and glass. In particular, the present invention relates to colloidal metal nanoparticles imbedded in a surface of the glass.

### BACKGROUND OF THE INVENTION

Recently, there has been a great deal of interest in the formation of composite materials containing noble metal nanoparticles and glass. Two traditional approaches are typically used to prepare these materials. First, a glass surface can be modified with a functionalized silane followed by immersion in a colloidal solution of the nanoparticle of interest. These materials have promising applications as sensors but they are limited by the instability of the particles on the glass surface. A second strategy uses a modified sol gel synthesis where the salt of the metal of interest is added to the sol gel matrix; the particles form as the solution is annealed. Unfortunately, this technique does not provide control over the particle size and shape.

Accordingly, there remains a need for a composite material of metal nanoparticles and glass that provides control over particle shape and size, and at the same time, provides mechanical stability of the nanoparticles on the glass surface.

### SUMMARY OF THE INVENTION

The present invention is directed towards methods for the preparation of colloidal metal nanoparticles, preferably gold particles, immobilized in a glass matrix by thermally annealing a monolayer of colloidal metal nanonanoparticles that are covalently attached to a glass surface. The present invention is also directed toward the resulting composite of particles imbedded in the glass surface. A further object of the invention is a method for preparing an array of zeptoliter vials in a glass surface, by preparing colloidal metal nanoparticles immobilized in a glass matrix, then dissolving the particles. A further object of this invention is to provide a method of embedding nanoparticles in a glass surface to control the optical features of the material.

### BRIEF DESCRIPTION OF THE FIGURES

FIG. 1A is a photograph of three glass slides containing monolayers of colloidal Au nanoparticles. Slide A was not thermally treated, Slide B was heated to the transformation temperature (557° C.) for thirty minutes, and Slide C was heated to the softening temperature (719° C.) for thirty minutes. Scotch tape was applied to the lower half of all three slides and removed. For the untreated slide, the Scotch tape removes the colloidal particles, but the colloidal particles remain firmly attached to the two treated slides.

FIG. 1B shows UV-vis spectra of a slide that contains a monolayer of colloidal Au particles (curve A), a similar slide that has been heated to the transformation temperature (557° C., curve B), and a slide that has been heated to the softening temperature (719° C., curve C). The surface plasmon band of Au is slightly red-shifted as a result of thermal treatment.

FIG. 2A shows a 1 μm×1 μm AFM image of monolayer of colloidal Au nanoparticles.

FIG. 2B shows a 1 μm×1 μm AFM image of a similar monolayer that has been heated to the softening point (719° C.) for thirty minutes.

FIG. 2C shows a 100nm×100 nm AFM image of a monolayer of particles that has been heated to the softening point.

FIG. 2D shows an NSOM image of the same 100 nm×100 nm region as in FIG. 2C.

FIG. 2E shows a monolayer of particles that has been heated to the softening point for thirty minutes and then etched with aqua regia for fifteen minutes.

### DETAILED DESCRIPTION OF THE INVENTION

The present invention is directed towards methods for the preparation of a glass and colloidal metal nanoparticles composite, in which the colloidal metal nanoparticles are immobilized in a glass matrix by thermally annealing a monolayer of colloidal metal nanoparticles that are attached to a glass surface. Many of the examples and embodiments herein describe the use of colloidal Au nanoparticles, but it is to be understood that any other metal (including alloys and mixtures of metals) is also contemplated by and within the scope of the invention. For example, metals include but are not limited to Ag, Cu, Al, or alloys comprised of two or more of Au, Al, Ag, and Cu. In other embodiments, the metal nanoparticles comprise a core of Ag, Al, Au, or Cu (or an alloy of two or more of these metals) substantially covered by a shell of any metal, any oxide, any sulfide, any phosphide, or any organic or inorganic polymer. In addition, although preferred embodiments employ metal nanoparticles that are substantially spherical, it is to be understood that other shapes are also contemplated. The glass may be of any type. Examples of suitable glasses include, but are not limited to SF11 glass slides (Schott Glass Technologies) BK7 microscope slides (Fisher Scientific), and glass coverslips (Fisher Scientific).

As an example, normal BK7 glass slides were washed with piranha (3:1H₂SO₄:30% H₂O₂) for fifteen minutes and then immersed in a 10 percent solution of either 3-mercaptopropyldimethoxymethylsilane or 3-mercaptopropyltrimethoxysilane for sixty minutes. The slides were rinsed with copious amounts of methanol and 18 MΩ distilled, deionized H₂O to remove physisorbed silane. The slides were then immersed in a solution of either 12 nm colloidal Au particles for approximately sixty minutes. After removal from the solution, the slides were rinsed with H₂O and wiped-off on one side using a cotton swab to remove any remaining particles. The optical properties of the slides were then measured using a HP 8453 UV-vis diode array spectrophotometer. They displayed the characteristic absorption band of colloidal Au. Slides with a band intensity of 0.06+/−0.01 absorbance units were utilized for thermal treatment.

The selected slides were dried and placed colloid side up in a furnace on mica sheets. The mica provides an atomically smooth surface and prevents the glass from melting into the porous ceramic interior of the furnace. The slides were heated for various amounts of time at either the softening point or the transformation temperature of the glass. For BK7 glass these are 557° C. and 719° C., respectively. After thermal treatment the optical properties of the slides were remeasured (spikes in the spectrum resulting from faulty diodes were removed manually).

The present invention is also directed toward the resulting composite of colloidal gold particles imbedded in a glass surface. The composite possesses mechanical stability while having optical properties substantially similar to a colloid monolayer. As used herein, “mechanical stability” refers to the ability of colloidal gold particles to remain associated with the glass surface when subjected to treatment that would remove a monolayer of colloidal gold particles from the glass surface. As used herein, “having optical properties substantially similar to a colloid monolayer” refers to the desirable properties traditionally associated with a colloid monolayer. Specifically, these materials possess the optical properties of monolayers of colloidal Au on glass, except the characteristic surface plasmon band of colloidal Au is slightly red-shifted. This red-shift is consistent with the formation of aggregates of particles as they sink into the glass. This trend is also supported by characterization of these particles with Atomic Force Microscopy (AFM).

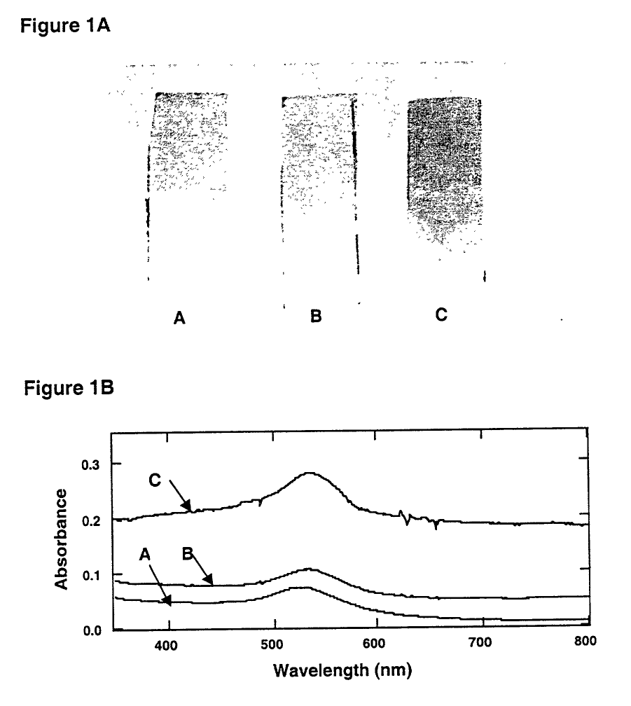

FIG. 1 A shows the effects of heating a film of a monolayer of colloidal Au particles that have been immobilized on a BK7 glass surface. Slide A represents a film that has not been subjected to thermal treatment. The colloidal Au has been removed from the lower half of this film by attaching and removing Scotch tape from its surface. Slide B shows of a similar film that has been heated to the transformation temperature for thirty minutes. Scotch tape was also applied to this film, but due to the annealing process, the particles remain firmly attached to the glass surface after the Scotch tape was removed. Slide C is a third film that has been heated to the softening point. Again, Scotch tape was attached to this film, but the particles are not removed because of the annealing process. This increased mechanical stability is essential for applications in photonics and display technology.

Thorough examination of FIG. 1A shows that slide C is slightly darker than either slides A or B. Spectroscopic characterization (FIG. 1B) indicates that the surface plasmon band has been slightly red-shifted in this film (Curve C) compared to the unannealed film (Curve A) and the film heated to the transformation temperature (Curve B).

A second key observation to make from FIG. 1 is that when heated to the softening point, the film is slightly deformed when it emerges from the furnace. This deformation results from the phenomenon of structural relaxation that occurs in several amorphous solids. Heating the glass past its softening point allows it to approach thermodynamic equilibrium resulting in a change in its physical properties, including enthalpy, mechanical modulus, dielectric permativity, refractive index, and specific volume. The deformation seen here results from the changes in these physical properties.

This result may be explained by migration of the particles on the glass surface. As the films are heated, the silane film is destroyed allowing the particles to move. As they move, they aggregate forming larger particles. Such larger particles display the red-shifted surface plasmon band observed here.

An alternative explanation is that the particles have become imbedded in the glass as a result of thermal treatment. It has been shown that the dielectric constant of the medium surrounding colloidal particles influences the optical properties of the particles. As the particles sink into the glass surface, their surrounding medium changes from air to glass, which have different dielectric constants. This changing dielectric constant explains the red-shift.

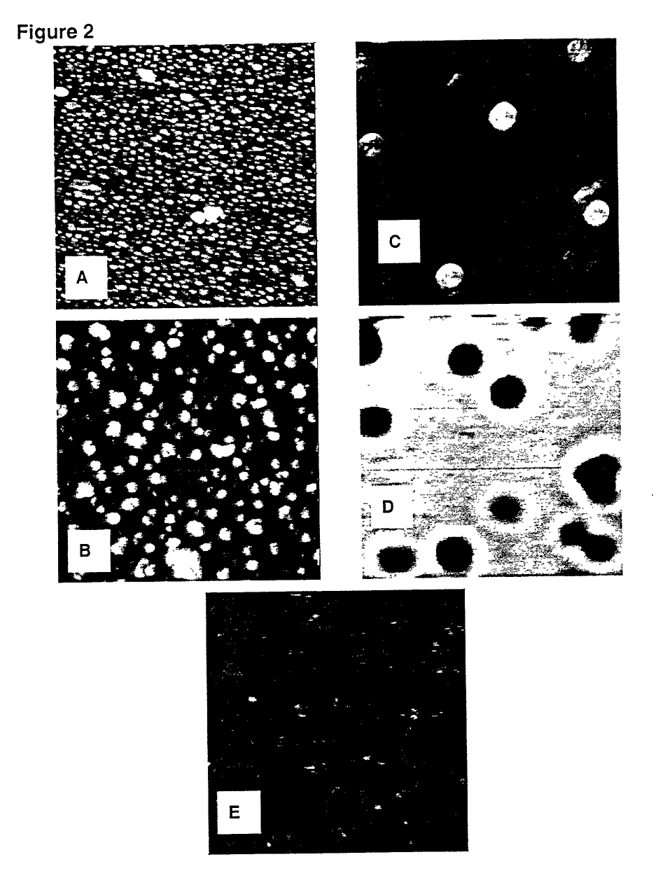

FIG. 2A shows a 1 μm×μm AFM image of a monolayer of colloidal Au particles on a glass surface. FIG. 2B is a 1 μm×1μm AFM image of one of these surfaces after thermal treatment. This particular slide was heated for thirty minutes at 719° C. (softening point). Twelve nm features can still be observed on the surface after annealing, but several larger features are also clearly evident. These larger features can either be aggregates of smaller particles, or they could be particles that have become imbedded in the glass. Many of the smaller features present are only a few nanometers above the surface of the glass, implying that most of the particle is actually submerged in the glass.

A significant number of particles appear to be unaccounted for, even taking the larger aggregates into account. Particles that are unaccounted for may possibly be completely submerged in the glass and consequently unable to be detected via AFM. AFM characterization of slides that were heated to the transformation temperature indicated that the particles remained positioned on the glass surface.

In order to test this notion, an alternative detection technique, Near-Field Scanning Optical Microscopy (NSOM), was used. In NSOM, light is directed through a sub-wavelength aperture onto a surface that is less than one wavelength from the aperture. By rastering the aperture over the surface, it is possible to image the surface based on its optical properties. The aperture is usually constructed from a micron-sized probe, and optical characterization can be done in tandem with topographic characterization. FIG. 2C is a 100 nm×100 nm AFM image of monolayer film that had been heated to the softening point. FIG. 2D is the NSOM image of the identical region. Several particles appear in the NSOM that are not present in the AFM. These particles have sunk beneath the surface of the glass where they can only be detected by NSOM, making NSOM an invaluable tool for studying these unique microstructures. Equally importantly, these samples may be an invaluable tool in the elucidation of the mechanism behind NSOM.

The composites of the present invention provide stable standards for NSOM. Using the methods described above, a composite can be made that has well-defined optical properties. Indeed, by selecting the metal, nanoparticle size and number, glass used, and annealing conditions, the optical properties can be varied or “tuned” as desired for a particular purpose. Because the nanoparticles are annealed to the glass, the resulting composite is stable and can be used as a reference for standardizing NSOM measurements. Selecting conditions so that the particles are entirely submerged in the glass results in a composite that has stable, measurable optical properties with little or no associated surface topography. Such optical standards are not limited to use in NSOM, but may also be employed with other types of scanning probe microscopes (e.g., that raster scan a probe in close proximity to the sample, including scanning tunneling microscopy (STM) and AFM.

A further object of the invention is a method for preparing an array of zeptoliter (1×10⁻²¹ liter) vials in a glass surface, by preparing colloidal Au particles immobilized in a glass matrix, then dissolving the particles with aqua regia. FIG. 2E is a film that had been heated to the softening point for thirty minutes. After cooling, the film was immersed in a solution of aqua regia for fifteen minutes. The aqua regia dissolved the Au particles leaving behind an array of nanoindentations. These indentations ranged in depth from 2 to 9 nm, implying that the particles are sinking approximately halfway into the surface of the glass and indicating that the indentations have a volume in the zeptoliter range. There appears to be a high degree of polydispersity in the lateral dimensions of these indentations. This polydispersity results from aggregation of the particles that is observed in FIG. 2B and implied by FIG. 1D.

Methods using some or all of the advantageous principles of the present invention may be applied in a wide variety of specific systems. The methods and examples disclosed herein are typical and illustrative, and are not to be regarded as limiting the scope of the invention or manner in which it may be practiced.

What is claimed is:

1. A method for preparing a composite of glass and colloidal metal nanoparticles, comprising:
a) covalently attaching colloidal metal nanoparticles to a glass surface;
b) heating the glass surface to the softening point; and
c) cooling the glass surface; whereby a composite of glass and colloidal metal nanoparticles is created.

2. The method of claim 1, wherein the colloidal metal nanoparticles are gold nanoparticles.

3. The method of claim 1, wherein the composite comprises colloidal gold nanoparticles imbedded in the glass surface.

4. A composite of glass and colloidal metal nanoparticles, wherein the colloidal metal nanoparticles are embedded in a surface of the glass.

5. The composite of claim 4, wherein the collodial metal nanoparticles are collodial gold nanoparticles.

6. The composite of claim 4, wherein the composite provides mechanical stability for the colloidal metal nanoparticles.

7. The composite of claim 4, wherein the optical properties of the colloidal metal nanoparticles are substantially the same as a monolayer of colloidal metal nanoparticles covalently attached to a surface of glass.

8. A method for making an array of zeptoliter vials, comprising:
a) covalently attaching colloidal metal nanoparticles to a glass surface;
b) heating the glass surface to the softening point;
c) cooling the glass surface; and
d) treating the glass surface with a reagent that dissolves the metal; whereby an array of zeptoliter vials is created.

9. The method of claim 8, wherein the colloidal metal nanoparticles are colloidal gold nanoparticles.

10. The method of claim 9, wherein the reagent that dissolves the metal is aqua regia.

11. A method for preparing an optical standard, comprising:
a) covalently attaching colloidal metal nanoparticles to a glass surface;
b) heating the glass surface to the softening point;
c) cooling the glass surface; whereby a composite of glass and colloidal metal nanoparticles is created; and
d) measuring at least one optical property of the resulting composite with an optical scanning probe microscope.

12. The method of claim 11, wherein the colloidal metal nanoparticles are gold nanoparticles.

13. The method of claim 11, wherein the composite comprises colloidal gold nanoparticles embedded in the glass surface.
